(19) United States
(12) Patent Application Publication
(10) Pub. No.: US 2015/0011680 A1
(43) Pub. Date: Jan. 8, 2015

(54) BIOSOURCED EPOXIDE RESINS HAVING IMPROVED REACTIVITY

(71) Applicants: UNIVERSITE MONTPELLIER 2 SCIENCES ET TECHNIQUES, Montpellier (FR); CENTRE NATIONAL DE LA RECHERCHE SCIENTIFIQUE, Paris (FR)

(72) Inventors: Jean-Pierre Habas, Montpellier (FR); Vincent Lapinte, Castries (FR); Amelia Ulloa Habas, Montpellier (FR); Olivia Giani, Le Cres (FR)

(21) Appl. No.: 14/379,582

(22) PCT Filed: Feb. 18, 2013
(86) PCT No.: PCT/FR2013/050331

§ 371 Date: Sep. 19, 2014

(30) Foreign Application Priority Data
Feb. 20, 2012 (FR) 1251539

(51) Int. Cl. C08G 59/02; C08G 59/50

(52) U.S. Cl. CPC C08G 59/027; C08G 59/5026; C08G 2170/00; C08G 2150/00
USPC 523/400; 528/288

(57) ABSTRACT

Biosourced epoxide resins are provided, including the product of the reaction of one or more biosourced epoxide lipid derivatives with at least one cross-linking agent in the presence of at least one co-reagent selected from among the glycidyl ether derivatives of biosourced polyols or the product of the reaction of one or more glycidyl ether derivatives of biosourced polyols with at least one cross-linking agent.

The present invention relates to novel biosourced epoxy resins with improved reactivity, the process for the manufacture thereof and the uses thereof.

Offering an excellent combination of physical and chemical properties, the epoxy resins constitute a class of thermosetting polymers used very widely in the fields of electronics, building, paints or in transport. The vast majority of those currently marketed are of petrochemical origin and are sometimes deemed toxic when they are based on the use of bisphenol A, such as resins of the DGEBA (diglycidyl ether of bisphenol A) type.

They are generally prepared by mixing an epoxidized compound with a hardener, which is also generally of petrochemical origin. These two components react together by polymerization in order to form cross-linked epoxy resins.

Faced with the exhaustion of petroleum resources but also to find a response to regulatory constraints that are more and more demanding (REACH, RoHS, etc.), various research projects have been conducted in an attempt to develop epoxy resins derived from biomass.

A first commercial solution consisted of proposing mixed formulations based on mixing petrochemical epoxy resins with biosourced epoxies. However, although these mixtures might lead to reactive formulations capable of meeting the requirements of industrial production conditions (Miyagawa H. et al. Macromol. Mater. Eng. (2004), 289, 629-635 and 636-641), they cannot claim the advantages of biosourced resins, whether in respect of the level of renewable carbon, toxicity, or dependence on petroleum. The petroleum-sourced matrices used most often are DGEBA and DGEBF (diglycidyl ether of biphenol F). By way of example, there may be mentioned the case of epoxidized soya oil (ESO) modified with DGEBA resin and hardened with triethylene tetramine (TETA) as described by Ratna D. et al. (Polym. Int. (2001), 50, 179-184). The same petrochemical resin was also modified by the addition of epoxidized grapeseed oil (ERO), or epoxidized linseed oil (ELO), to epoxidized sea kale oil.

Secondly, formulations based on entirely biosourced epoxy resins, in particular prepared from compounds derived from vegetable oils, have been proposed.

A vegetable oil is, as its name suggests, derived from biomass. It may be defined as a statistical product composed predominantly of triglycerides but also, to a lesser extent, of diglycerides and monoglycerides. The structure of the triglyceride units may be summarized as the grafting of three fatty acids onto one glycerol unit. The term unsaturated fatty chains is used to describe those bearing carbon-carbon double bonds (C═C). Some examples of unsaturated fatty chains are presented in Table 1.

TABLE 1
Unsaturated fatty acids

| Fatty acid | Chemical formula |
|---|---|
| Palmitoleic acid | CH₃(CH₂)₅CH═CH(CH₂)₇COOH |
| Oleic acid | CH₃(CH₂)₇CH═CH(CH₂)₇COOH |
| Linoleic acid | CH₃(CH₂)₄CH═CH—CH₂—CH═CH(CH₂)₇COOH |
| Linolenic acid | CH₃—CH₂—CH═CH—CH₂—CH═CH—CH₂—CH═CH(CH₂)₇COOH |
| Eleostearic acid | CH₃—(CH₂)₃—CH═CH—CH═CH—CH═CH(CH₂)₇COOH |
| Ricinoleic acid | CH₃—(CH₂)₄CH—CH(OH)—CH₂—CH═CH(CH₂)₇COOH |

The associated fatty acids are present naturally in the following vegetable oils: linseed oil, sunflower oil, colza oil, soya oil, olive oil, grapeseed oil, tung wood oil, cotton oil, maize oil, hazelnut oil, walnut oil, coconut oil, palm oil, castor oil, cashew nut oil and peanut oil. Unsaturated fatty acids also occur in animal oils, such as for example in lard, beef tallow and fish oils (salmon, sardine, anchovy, mackerel, tuna, herring, etc.).

The presence of unsaturations in the fatty chains is particularly useful as the latter may be converted into oxirane groups using peracids or hydrogen peroxide. This step is also designated by the term epoxidation.

Thus, Tan S. G. et al. (Polymer-Plastics Technology and Engineering, (2010) 49: 1581-1590) describe a thermosetting resin formulated by the reaction of epoxidized soya oil with a methylhexahydrophthalic anhydride (MHHPA) as hardener and in the presence of tetraethylammonium bromide as catalyst. The mixture is put in a mould and then cross-linked at 140° C. Polymerization is only complete after 3 hours.

Gerbase A. E. et al. (J. Am. Oil Chem. Soc. (2002), 79, 797-802) report the mechanical properties of epoxy resins based on soya oil obtained by the reaction of said soya oil with different cyclic acid anhydrides in the presence of tertiary amines. The mixtures are generally heated at 150° C. for 14 hours.

Boquillon N. et al. (Polymer (2000) 41, 8603-8613) describe the properties of epoxy resins obtained by the reaction of epoxidized linseed oil with various hardeners of the anhydride type in the presence of different catalysts. The treatment cycle is 15 hours at 150° C. and then 1 hour at 170° C. The formulation of the linseed oil/tetrahydrophthalic anhydride (THPA)/2-methylimidazole mixture leads to resins having the best mechanical properties after cross-linking.

Chrysanthos M. et al. (Polymer (2011) 52, 8603-8613) describe biosourced resins derived from diglycidyl ether of epoxidized isosorbide of vegetable origin as a replacement for DGEBA. The hardener used is isophorone diamine and the treatment cycle is 1 hour at 80° C. followed by 2 hours at 180° C.

International application WO 2008/147473 relates to biosourced polymers obtained by the reaction of a resin based on glycidyl ethers of anhydrosugars of vegetable origin, for example isosorbide, isomannide or isoiodide with a hardener of biosourced or non-biosourced origin. When the cross-linking step is carried out at temperatures comprised between 100° C. and 150° C., it takes about 3 hours; when it is carried out at very high temperatures, of the order of 250° C., it takes 30 minutes. Tests of cross-linking at ambient temperature show that it takes 24 hours in order to obtain complete cross-linking.

International application WO 2010/136725 relates to a method of preparing thermosetting epoxy resins formulated from epoxidized natural phenolic compounds and a hardener. These phenolic compounds are derived from biomass, in particular from plants, algae, fruits, or trees and the hardener is a compound bearing primary or secondary amine functions, for example cycloaliphatic compounds, in particular Epamine PC 19. These resins are cross-linked at ambient temperature for times of several hours.

Thus, the polymerization of epoxy resins, partly or entirely biosourced, described up to now often needs to be carried out at very high temperatures and often is still too slow for the requirements of industrial production, even when catalysts are used.

The purpose of the present invention is to propose a wide range of resins based on natural oils and having very high reactivity and therefore capable of cross-linking at ambient temperature and with short polymerization times while offering additional mechanical properties.

Another objective of the present invention is to be able to control the cross-linking of these resins in terms of time and temperature.

An additional objective is to be able to adjust the final properties of these resins for a targeted application.

These objectives are achieved by the present invention, which supplies resins derived either from natural oils formulated in the presence of a compound having a structure of biosourced origin and bearing easily accessible epoxide terminations called co-reactant, or from said compound alone.

In fact, the inventors used biosourced structures bearing epoxide terminations that are more easily accessible than those borne by the triglyceride units and yet are capable of participating directly in formation of the polymer network or even of forming a polymer network, even in the absence of epoxldized natural oils. Regardless of the temperature, the mixtures thus formulated have much shorter gel times than the formulation without co-reactant, even in the absence of catalyst. They are also capable of cross-linking at ambient temperature. The formulations prepared from co-reactant alone are also capable of displaying short gel times, even if working at ambient temperature or in the absence of catalyst.

Thus, the invention relates to biosourced epoxy resins comprising the product of reaction:
a. of one or more biosourced epoxidized lipid derivatives, with at least one cross-linking agent, in the presence of at least one co-reactant selected from the glycidyl ether derivatives of biosourced polyols, or
b. of one or more glycidyl ether derivatives of biosourced polyols with at least one cross-linking agent.

In an advantageous embodiment of the invention the ratio of the number of reactive chemical groups of the cross-linking agent to the total number of epoxy groups present in the epoxidized oil/co-reactant mixture is equal to the ratio of the number of reactive chemical groups of the cross-linking agent to the total number of epoxy groups of the lipid derivative or derivatives if they were used as the sole source of epoxy groups.

In the resins according to the invention, the co-reactant may be used in addition to or replacing the epoxy groups of the epoxidized lipid derivative. Q is used to denote the ratio

$$\frac{\begin{matrix}number of reactive groups \\ of the cross \text{-} linking agent\end{matrix}}{\begin{matrix}number of epoxy groups borne by \\ the lipid derivatives + the at least one co \text{-} reactant\end{matrix}}$$

Within the meaning of the present invention, by “epoxide resins” or “epoxy resins” is meant the product of the reaction of an epoxidized compound with a cross-linking agent. Epoxy resins are examples of thermosetting resins. By “epoxidized compound” is meant a compound into which one or more epoxide groups have been introduced. An epoxidized compound may also be called epoxide or “oxirane” or else “epoxy”.

By “epoxide function” or “epoxy group” or “oxirane function” or “oxirane group” is meant a cyclic function with three ring members having two carbons and one oxygen atom.

Within the meaning of the present invention, by “reactive chemical groups of the cross-linking agent” is meant any chemical group or function capable of reacting by establishing covalent bonds with the epoxy groups of the lipid derivatives or of the co-reactant.

Within the meaning of the present invention, the term “biosourced” denotes a product derived from biomass. Biomass describes the total mass of living organisms of vegetable or animal origin in a defined environment, called biotope, and the resources resulting therefrom through direct, indirect or potential use for humanity.

According to the present invention, the number of reactive groups and of epoxy groups may be measured by any method known to a person skilled in the art, in particular by chemical methods (chemical analysis in the presence of an acid halide) or by NMR or FTIR spectroscopy (Lee, H.; Neville, K., Handbook of Epoxy Resins, McGraw-Hill: New York, (1967)).

Within the meaning of the present invention, by “cross-linking agent” or “hardener” is meant a compound that reacts with the epoxides to allow the creation of a three-dimensional polymer network. This is called cross-linking. According to the invention, the hardeners are either of biosourced origin, or are those usually employed for preparing the petroleum-sourced resins and are selected from the group comprising compounds bearing acid functions such as acid anhydrides, compounds bearing primary or secondary amines such as diamines, polyamines and mixtures thereof, diacids and polyacids, alcohols including the phenols and polymercaptans and mixtures of at least two of these agents.

There may be mentioned, as examples of acid anhydrides: succinic anhydride, maleic anhydride, dodecenylsuccinic anhydride, phthalic anhydride, hexahydrophthalic anhydride, methylhexahydrophthalic anhydride, methyl-tetrahydrophthalic anhydride and methyl-endo-methylenetetrahydrophthalic anhydride.

There may be mentioned, as examples of amines:
the aliphatic diamines of general formula H₂N—Ra—NH₂ where Ra is an aliphatic chain, in particular ethylenediamine, hexamethylenediamine, bis(3-aminopropyl)amine, 1,10-decanediamine. Some biosourced examples: 1,4-butanediamine, 1,5-pentanediamine or else 1,12-dodecanediamine, 1,18-octadecanediamine,
the cycloaliphatic diamines of generic form H₂N—Rb—NH₂ where Rb is an aliphatic cyclic unit, in particular isophorone diamine also denoted by the abbreviation IPDA, the aromatic diamines of generic form H₂N—Rc—NH₂ where Rc is an aromatic ring, in particular phenylenediamine in its ortho, meta, para forms, xylylenediamine in its ortho, meta, para forms, 2,5-diaminotoluene, 4,4′-diaminobiphenyl, 4,4′-diaminodiphenylmethane. A biosourced example: lysine,
the polyamines bearing at least 5 N—H groups, in particular diethylenetriamine, triethylenetetramine, tetraethylenepentamine, poly(oxypropylene)triamine and the polyetheramines or polyoxyalkyleneamines. Some biosourced examples: the natural polypeptides.

There may be mentioned, as examples of diacids, the following molecules: heptanedioic acid HOOC—(CH₂)₅—COOH; phthalic acid; isophthalic acid; fumaric acid, maleic acid, terephthalic acid, succinic acid, itaconic acid, hexahydrophthalic acid, methyl hexahydrophthalic acid, tetrahydrophthalic acid, methyl tetrahydrophthalic acid, and pyromellitic acid.

There may be mentioned, as examples of polymercaptans or polythiols, the following molecules: 1,2,5-trimercapto-4-thiapentane, 3,3-dimercaptomethyl-1,5-dimercapto-2,4-dithiapentane, 3-mercaptomethyl-1,5-dimercapto-2,4-dithiapentane, 3-mercaptomethylthio-1,7-dimercapto-2,6-dithiaheptane, 1,2,7-trimercapto-4,6-dithiaheptane, 3,6-dimercaptomethyl-1,9-dimercapto-2,5,8-trithianonane, 1,2,9-trimercapto-4,6,8-trithianonane, 3,7-dimercaptomethyl-1,9-dimercapto-2,5,8-trithianonane, 4,6-dimercaptomethyl-1,9-dimercapto-2,5,8-trithianonane, 3-mercaptomethyl-1,6-dimercapto-2,5-dithiahexane, 3-mercaptomethylthio-1,5-dimercapto-2-thiapentane, 1,1,2,2-tetrakis(mercaptomethylthio)ethane, 1,1,3,3-tetrakis(mercaptomethylthio)propane, 1,4,8,11-tetramercapto-2,6,10-trithiaundecane, 1,4,9,12-tetramercapto-2,6,7,11-tetrathiadodecane, 2,3-dithia-1,4-butanedithiol, 2,3,5,6-tetrathia-1,7-heptanedithiol, 2,3,5,6,8,9-hexathia-1,10-decanedithiol.

By “biosourced epoxidized lipid derivatives” is meant either unsaturated fatty acids present naturally in the epoxidized form in natural vegetable or animal oils, or compounds obtained by epoxidation of unsaturated fatty acids, of esters of unsaturated fatty acids, said unsaturated fatty acids comprising one or more carbon-carbon double bonds and being derived from natural vegetable or animal oils. These unsaturated fatty acids comprise at least 12 carbon atoms, even more advantageously between 12 and 20 carbon atoms, in particular 12, 14, 16, 18 or 20 carbon atoms.

In an advantageous embodiment of the invention, the natural vegetable oil in which the epoxidized lipid derivatives are present naturally is vernonia oil.

In another advantageous embodiment of the invention, the epoxidized lipid derivative or derivatives are obtained by epoxidation of lipids extracted from natural vegetable or animal oils. As examples of vegetable oils, there may be mentioned linseed oil, hemp oil, sunflower oil, colza oil, soya oil, olive oil, grapeseed oil, tung wood oil, cotton oil, maize oil, hazelnut oil, walnut oil, coconut oil, palm oil, castor oil, cashew nut oil, peanut oil, calabash oil, margosa oil and loofah oil and mixtures thereof. As examples of animal oil, there may be mentioned lard, beef tallow and fish oils such as oil from salmon, sardine, anchovy, mackerel, tuna, or herring.

Advantageously, linseed oil or hemp oil will be selected. In fact, the oil extracted from the seeds of these plants is very rich in unsaturated fatty acids (>90%) in particular with a high proportion of linoleic and linolenic fatty acids (see Table 2 for linseed oil).

TABLE 2
typical composition of a linseed oil

| | unsaturated fatty acids | | |
|---|---|---|---|
| | 90% | | |
| saturated fatty acids | oleic acid | linoleic acid | linolenic acid |
| 10% | 12-34% | 17-24% | 35-60% |

The upgrading of linseed oil does not in any way conflict with production oriented initially towards food production, which prefers sunflower, soya, colza, peanut or olive oil. Linseed oil is already offered commercially in epoxidized form for this purpose. Thus, its epoxidation allows treatment of a model molecule bearing from 1 to 6 epoxide groups, which will be as many functions as can react with reactive groups of the cross-linking agent to form macromolecular networks.

The epoxidized lipid derivatives are commercially available or are prepared by epoxidation by any method known to a person skilled in the art, for example by reaction with hydrogen peroxide.

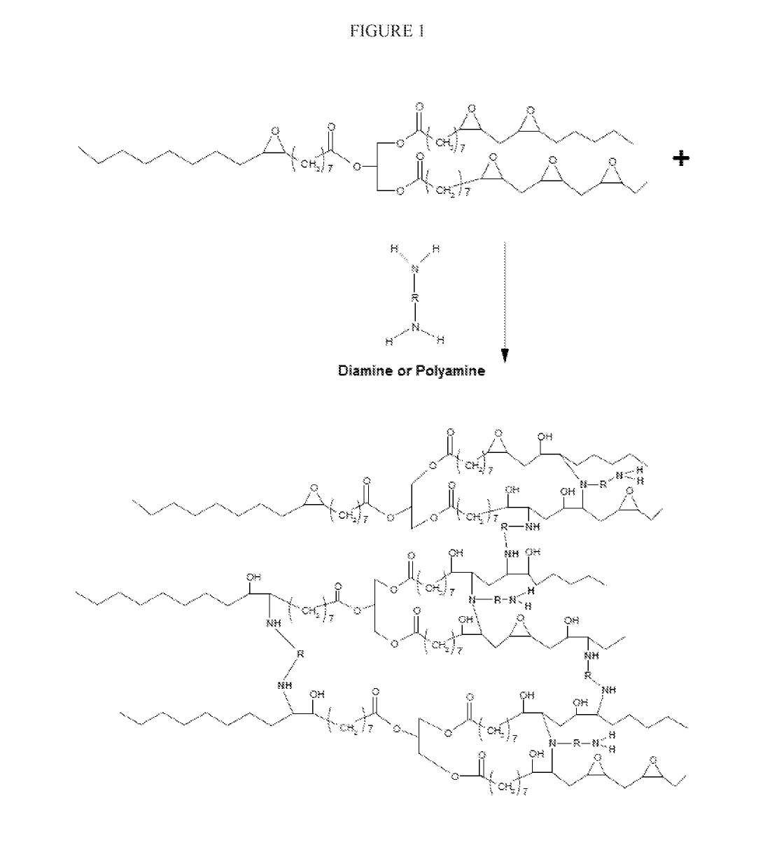

In the epoxidized lipid derivatives, in particular in the epoxidized vegetable oils, the oxirane groups present on the chains of fatty acid esters are arranged along the main backbone and therefore offer limited accessibility to the reactive groups of the cross-linking agent (see FIG. 1). In contrast to vegetable oils, the glycidyl ether derivatives of biosourced polyols used according to the invention, either as co-reactants, or as unique carriers of epoxy groups, comprise oxirane groups that are very accessible as they are located at the end of linear aliphatic molecular segments smaller than the fatty acids present in the vegetable oils as defined above. In other words, these molecular segments have fewer than 12 atoms. The preferential arrangement of the oxirane groups in the co-reactant endows the latter with increased reactivity with respect to the reactive groups of the cross-linking agent in comparison with vegetable oil. This particular feature results in an easier and faster cross-linking step. These co-reactants therefore participate directly in the polymer network and even if their increased reactivity allows shortening of the gel times, they must not be confused with “simple” catalysts, which are not involved as structural elements of the polymer network. When these molecules of low molecular weight are used alone, owing to their increased reactivity they provide an easier and faster cross-linking step, even in the absence of oil. The quantity of cross-linking agent is advantageously selected so as to be able to consume all of the epoxy functions of the oil and of the co-reactant, which gives a continuous macromolecular network whose unit cell displays a smaller average size than that characteristic of the network obtained merely by the reaction of the epoxidized vegetable oil with the cross-linking agent. The thermomechanical properties of the resins according to the invention are thus better than those obtained by cross-linking of the epoxidized lipid derivative alone. A person skilled in the art is able, based on his knowledge, to determine the necessary quantities of each compound in respect of the final mechanical rigidity of the material When the glycidyl ether derivatives of polyols are used as the sole source of epoxy functions, the quantity of cross-linking agent is advantageously selected so as to be able to consume all of said epoxy functions.

Within the meaning of the present invention, by “polyols” is meant aliphatic compounds comprising at least two hydroxyl groups. They are biosourced and are selected either from glycerols and polyglycerols derived from natural, in particular vegetable, oils or from sugar derivatives that are sufficiently hydrophobic so that they are soluble in lipids. As examples, there may be mentioned sorbitol, xylitol and mannitol.

In an advantageous embodiment of the invention, the glycidyl ether derivative of polyol, used as co-reactant or alone, is obtained by epoxidation of glycerol or of a polyglycerol derived from vegetable oils and corresponds to formula (I)

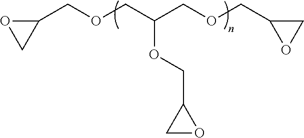

where n is an integer comprised between 1 and 20, in particular the glycidyl ether derivative of glycerol of formula (Ia)

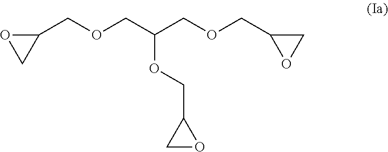 [SMILES: C(OCC1CO1)C(COCC1CO1)OCC1CO1]

and the glycidyl ether derivative of diglycerol of formula (Ib)

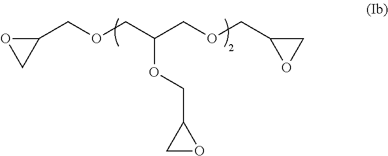

In another advantageous embodiment of the invention, the glycidyl ether derivative of polyol used as co-reactant or &one is obtained by epoxidation of a sugar, and is in particular the glycidyl ether derivative of sorbitol of formula (II)

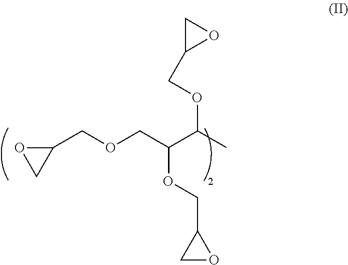

In formulae (I), (Ia), (Ib) and (II), each molecular segment bearing an oxirane function comprises, in addition to said function, 2 or 3 atoms, or respectively one oxygen atom and one carbon atom or one oxygen atom and two carbon atoms.

When these glycidyl ether derivatives of polyols are used as co-reactants, it is possible to conceive a wide range of reactive formulations based on epoxidized vegetable oils. In fact, in addition to the effect due to their proportion in the formulation, their variety of molecular structures (glycidyl ether of glycerol, glycidyl ether of sorbitol) or even macromolecular structures (polyglycerol, polyglycidyl ether) allows a very wide range of functionalities (2, 3, 4, 6 and n). It is thus possible to tailor the physicochemical properties of the final material obtained by cross-linking the formulation comprising epoxidized vegetable oil, one or more cross-linking agents (polyamine or anhydride) and one or more epoxidized co-reactants. The choice of the respective proportions of each component is within the capability of a person skilled in the art.

In a particular embodiment of the invention, the at least one cross-linking agent is selected from
a. the group comprising compounds bearing amine functions, said compounds, when bearing primary amine functions, being selected from the group comprising the diamines, the polyamines as defined above and mixtures thereof, or
b. the group of acid anhydrides.

In another particular embodiment of the invention, when the at least one cross-linking agent is a compound bearing N—H groups, belonging to primary or secondary amine functions, the ratio Q_{NH}:

$${Q}_{NH} = \frac{number of N \text{-} H groups}{\begin{matrix}\begin{matrix}number of epoxy groups borne by \\ ( the lipid derivatives + the at least one co \text{-} reactant ) \\ or by the glycidyl ether \end{matrix} \\ derivatives of polyols when they are used alone\end{matrix}}$$

is advantageously such that 1 N—H group corresponds to each epoxy group. This is equivalent to saying that the ratio of the number of N—H groups to the number of epoxy groups is equal to unity.

In another particular embodiment of the invention, when the at least one cross-linking agent is a compound bearing acid anhydride groups, the ratio Q_{anhydride}

$${Q}_{anhydride} = \frac{number of acid anhydride groups}{\begin{matrix}\begin{matrix}number of epoxy groups borne by \\ ( the lipid derivatives + the at least one co \text{-} reactant )\end{matrix} \\ or by the glycidyl ether derivatives of polyols when \\ they are used alone\end{matrix}}$$

is advantageously such that 1 acid anhydride group corresponds to each epoxy group. This is equivalent to saying that the ratio of the number of acid anhydride groups to the number of epoxy groups is equal to unity.

In the case when the ratio Q_{NH} or Q_{anhydride} is different from 1, reaction between the epoxy compound and the cross-linking agent (polyamine or acid anhydride) is still possible. A person skilled in the art will be able to define the optimum stoichiometry so as to obtain a material capable of satisfying the technical requirements of the intended application.

The resins according to the invention may, moreover, contain additives that are usual in this field, for example diluents, solvents, pigments, fillers, plasticizers, antioxidants, stabilizers. These additives may or may not be biosourced.

The invention also relates to a method for formulating biosourced epoxy resins comprising a step of mixing one or more biosourced epoxidized lipid derivatives with at least one cross-linking agent, in the presence of at least one co-reactant selected from the glycidyl ether derivatives of biosourced polyols.

In a particular embodiment of the invention, the method for preparing biosourced epoxy resins comprises the following steps:
a. mixing one or more biosourced epoxidized lipid derivatives,
b. adding the co-reactant and then carrying out a mixing operation to obtain a homogeneous epoxy mixture,
c. adding the cross-linking agent to said mixture and then carrying out a further mixing operation,
d. then leaving the resin to react.

The mixing operations in steps b) and c) may be carried out by any technique known to a person skilled in the art, in particular by mechanical mixing. The duration of mixing in step b) is of the order of 1 to 5 minutes and is easily determined by a person skilled in the art. The duration of mixing in step c) is of the order of one minute.

Step d) is carried out under conditions of time and temperature determined by previously conducting experiments conventionally applied for optimizing the cross-linking of a thermosetting polymer (differential scanning calorimetry (DSC), steady-state or oscillating rheometry, dielectric techniques, etc.).

The cross-linking agent and the co-reactant may be in solid or liquid form. When the cross-linking agent and/or the co-reactant used are in solid form, it is preferable to preheat each constituent of the formulation separately at a temperature that allows melting of all the compounds. This precaution guarantees homogeneity of the future mixture. Once this temperature is reached, the co-reactant may be added to the oil, followed by the cross-linking agent in accordance with steps b) to d) described above.

In the process of the invention, the savings in terms of temperature and/or time required for the cross-linking operation are very large relative to the processes commonly used. Thus, the resin can be hardened in less than 10 minutes at 80° C., advantageously in less than 5 minutes.

In another embodiment of the invention, the process may also be carried out in the presence of a catalyst if this proves necessary. In this case the catalysts are those usually employed with epoxy formulations, for example tertiary amines, imidazoles.

The epoxy resins according to the invention are derived from biosourced materials and meet the expectations of the new environmental rules in particular decreed by the REACH regulations. Thus, the resins according to the invention have a proportion of renewable carbon of at least 50%, advantageously of at least 85%, even more advantageously at least 95%; they can therefore be used as substitutes for petrochemical resins as products from Green Chemistry.

In health respects, the resins according to the invention do not have the toxicity of certain petrochemical derivatives, in particular those derived from bisphenol A, which is the object of much criticism.

Their low release of VOCs is an extra plus.

As the resins according to the invention are endowed with very rapid cross-linking kinetics (which may be less than 5 minutes at a temperature of 80° C.) compared to the conventional biosourced products even in the presence of initiator and/or catalyst, they therefore meet the requirements of industrial productivity in particular in the composites sector. In this last-mentioned field, their reactivity is comparable to that of the unsaturated polyesters.

Being compatible with cold polymerization, they have low energy consumption and for this reason do not require complex, expensive equipment for curing. However, by placing the previously hardened part at ambient temperature, an increase in cross-linking may be obtained by thermal post-treatment in a suitable enclosure (furnace, stove, etc.). This operation is carried out concurrently, i.e. away from the device used initially for conferring the geometry of the intended object after casting the resin (mould, template, etc.) and it allows simultaneous treatment of several parts if required (no immobilization of the main processing equipment).

The biosourced epoxy resins according to the invention may be used as substitutes for the resins derived from petrochemistry, in particular for manufacturing composites for mechanical construction or for building and in structural parts. There may be mentioned, as examples, construction (profiles, beams, tools), transport (moulded articles, body panels), aerospace (internal or structural elements of aircraft), water sports (corrosion-resistant parts: hulls, appendages such as keels, rudder blades, etc.), sports and leisure (skis, skates, canoes, racket frames, snowboards etc.). They may also be used for applications involving structural parts exposed to fatigue or parts subjected to thermal variations or as adhesives, preferably as structural adhesives or as surface coatings.

The invention is illustrated in FIGS. 1 to 5 and by examples 1 and 2 given below.

FIG. 1 illustrates the cross-linking reaction of an oil epoxidized with a diamine as known from the prior art.

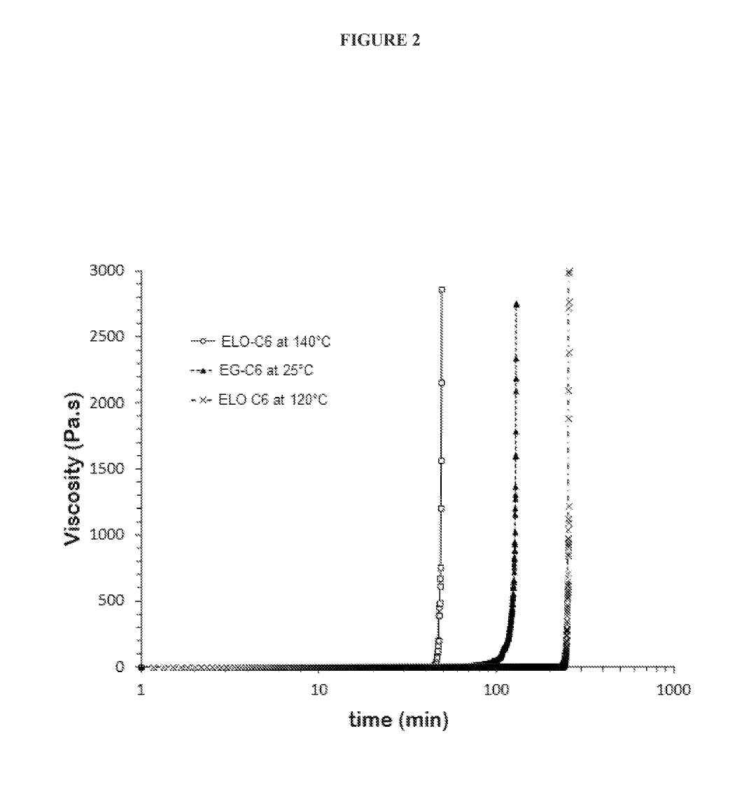

FIG. 2 illustrates viscosimetric monitoring of formulations based on epoxidized linseed oil and hexamethylenediamine and of formulations based on epoxidized glycerol and hexamethylenediamine according to example 1. ELO-C6: mixture of epoxidized linseed oil and hexamethylenediamine; EG-C6: mixture of epoxidized glycerol and hexamethylenediamine. In both cases, the ratio of the number of N—H groups to the number of epoxy groups is constant and equal to 1.

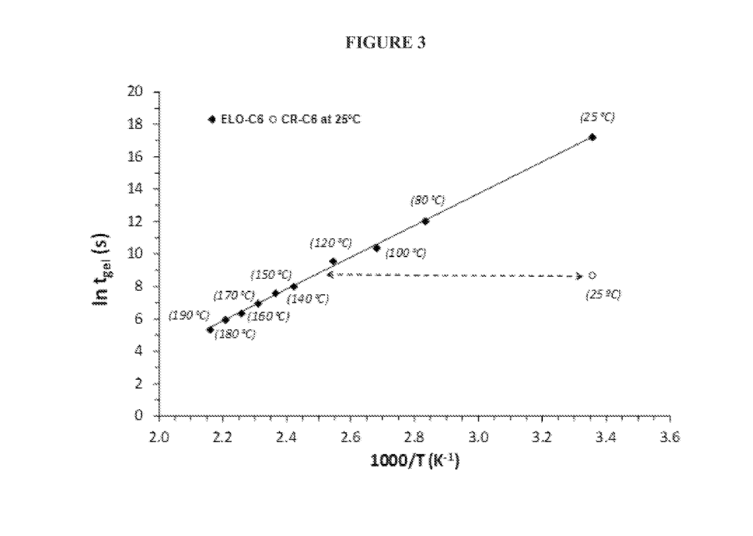

FIG. 3 illustrates comparison of the reactivities of the co-reactant (CR) of the epoxidized glycerol type and of epoxidized linseed oil (ELO) with respect to hexamethylenediamine (C6) measured by the effect of temperature on the gel time.

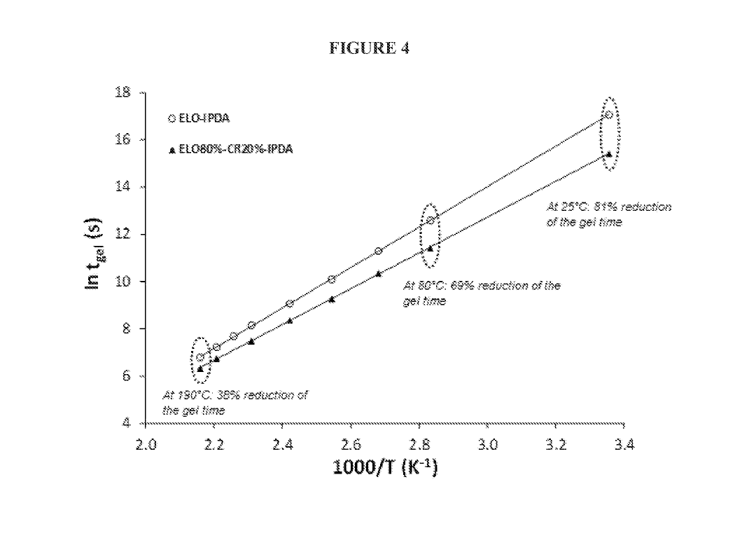

FIG. 4 illustrates the gel times measured at different temperatures, of a mixture comprising 1 mole of epoxidized linseed oil to 1.5 mol of isophorone diamine (ELO-IPDA) compared to those of a mixture according to the invention comprising a mixture of epoxidized linseed oil and co-reactant in 80/20 ratio (80% of the number of epoxy groups are supplied by the oil ELO and 20% by the co-reactant) with isophorone diamine (IPDA), keeping the ratio of the number of N—H groups to the number of epoxy functions equal to the preceding case (i.e. equal to 1).

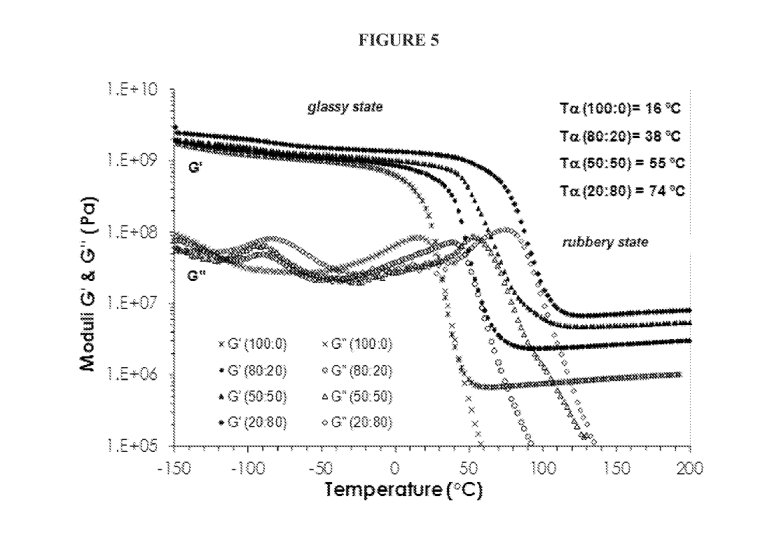

FIG. 5 illustrates the effect of adding co-reactant of the epoxidized glycerol type on the thermomechanical performance of the mixtures based epoxidized linseed oil (ELO) and isophorone diamine (IPDA). The curves show the evolution of the viscoelastic components of various formulations according to the invention. Component G′ is called “storage modulus”; it translates the energy stored and then returned by the material and illustrates its mechanical rigidity. Component G″ denotes the “loss modulus” characteristic of the mechanical energy dissipated owing to the molecular motion taking place within the material. The principal relaxation of the polymer, associated with the rheological manifestation of the glass transition of the macromolecular network, leads to formation of a peak on the curve of G″, whose maximum makes it possible to estimate Tα of the material, in other words its glass transition temperature in the rheological meaning. Just one is detected by mixing, demonstrating the existence of a single macromolecular network; (100:0) represents a mixture in which all the epoxy groups are supplied by ELO. In other words, the mixture does not contain a co-reactant; (80:20) represents a mixture in which the epoxy groups are supplied at 80% of the total number by ELO, the remaining 20% being supplied by the co-reactant; (50:50) represents a mixture in which the epoxy groups are supplied in equal proportion by ELO and the co-reactant; (20:80) represents a mixture in which the epoxy groups are supplied at 20% of the total number by ELO, the remaining 80% being supplied by the co-reactant.

### EXAMPLE 1

### Properties of the Mixture of Linseed Oil and Hexamethylenediamine and of the Mixture of Epoxidized Glycerol and Hexamethylenediamine

1.1. Preparation of the Mixtures
a. The diamine hexamethylenediamine is solid at ambient temperature. Each component of the formulations, namely epoxidized linseed oil (ELO), the diamine (C6) or epoxidized glycerol (EG), is heated separately to a temperature of 45° C. for example on a water bath.
b. The molten diamine is then added to the linseed oil to form the ELO-C6 mixture defined advantageously by a molar ratio of 1:1.5. The number of epoxy functions is then equal to the number of N—H functions.
c. This last-mentioned mixture is then mixed at a temperature of 45° C. for one minute and is then heated to the desired cross-linking temperature. In example 1, two cases are described, namely 120° C. and 140° C.
d. The EG-C6 mixture is obtained by pouring the molten diamine into the epoxidized glycerol heated beforehand to 45° C. to avoid any risk of crystallization of the cross-linking agent. Advantageously, the stoichiometry of the EG-C6 mixture is 1:0.75 (or a ratio (N—H/epoxy)=1 as in the case of the preceding ELO-C6 mixture). Polymerization may be carried out starting from 25° C. as in the case shown in FIG. 2.

1.2. Measurement of the Gel Time

The technique adopted for measuring the gel time is steady-state viscosimetry. The test consists of recording the evolution of the viscosity of the mixture at constant temperature (that selected for cross-linking) by means of a rotary rheometer equipped for example with “parallel plate” geometry. The gel point associated with critical formation of the macromolecular network is then defined by the time at which the viscosity of the mixture diverges. In practice, this time is detected by taking the point of intersection of the asymptote to the viscosity curve in the region of divergence with the time axis.

1.3. Results

The results are given in FIGS. 2 and 3.

FIG. 2 shows that direct reaction of epoxidized glycerol (EG or CR) with the diamine C6 is possible even at 25° C. This result emphasizes firstly that epoxidized glycerol is a co-reactant and for this reason must not be confused with a simple catalyst or initiator. In other words the co-reactant participates directly in formation of the macromolecular network, itself reacting directly with the units of diamine C6. At 25° C., the CR-C6 mixture displays a gel time of 100 minutes, a value intermediate between that observed with the ELO-C6 pair at 140° C. (49 minutes) and 120° C. (249 minutes) (FIG. 2).

FIG. 3 illustrates that the evolution of the gel time of the ELO-C6 mixture with the temperature can be described by an Arrhenius law. This same figure shows that the value of the gel time of the CR-C6 pair at 25° C. is equivalent to that of the ELO-C6 mixture at 130° C. Thus, the increase in reactivity of CR relative to ELO makes caking possible at low temperature, which allows modification of the formulations in contact with thermosensitive substrates.

### EXAMPLE 2

### Epoxy Resin Prepared from Epoxidized Linseed Oil, Epoxidized Glycerol as Co-Reactant and Isophorone Diamine (1PDA)

2.1. Preparation of the Resin
a. The ELO-IPDA mixture is prepared by pouring the liquid diamine into the oil at ambient temperature. In this example, the molar stoichiometry of the ELO-IPDA mixture is 1:1.5 or a ratio (N—H/epoxy)=1.
b. The temperature of the ELO-CR mixture is maintained at ambient temperature and mixing is carried out for 5 minutes before cross-linking.
c. The stoichiometry of the ELO-CR-IPDA mixture is calculated so as to confer on the medium a ratio of the number of epoxy groups to the number of amine groups equal to that selected in the case of the ELO-IPDA binary mixture. Moreover, in this example, 80% of the number of the epoxy groups present in the medium are borne by the oil ELO and 20% by the co-reactant. The ratio (N—H/epoxy) is again equal to 1. The composition by weight of the formulation is 68.1% of ELO, 9.6% of CR, 22.3% of IPDA. In terms of molar composition, the ELO-CR-IPDA stoichiometry is 1:0.5:1.9.

2.2. Results

The results are given in FIGS. 4 and 5.

In both formulations, the evolution of the gel time with the temperature is described by an Arrhenius law (FIG. 4). However, it can be seen that replacement of epoxidized lipid units with epoxide units of the co-reactant gives a very large reduction in gel time. For a mixture 80% ELO-20% CR-IPDA, the relative reduction in gel time, compared with the ELO-IPDA mixture (at constant ratio “epoxy groups/amine groups”) is:

81% at 25° C.

69% at 80° C.

38% at 190° C.

The benefit of the co-reactant is therefore especially pronounced in the low-temperature range as it makes it possible to overcome the low reactivity of the epoxidized oils.

The co-reactant has certainly been introduced into the main network. Owing to the smaller size of its molecular segments, the presence of the co-reactant leads to an increase in the rigidity of the polymer network. This point is clearly demonstrated by the increase in Tα (≅Tg) with increase in the proportion of co-reactant (FIG. 5). At the same time a reduction is observed in the size and average mass Mc of the unit cell of the network. This evolution is reflected in the increase in the value of modulus G′ in the rubbery zone, since G′=(1/Mc). In other words, the co-reactant not only contributes to improving the reactivity of the formulation, it also allows considerable improvement in the thermomechanical properties of the final material.

1. A biosourced epoxy resin comprising the product of reaction of one of:
a. of one or more biosourced epoxidized lipid derivatives, with at least one cross-linking agent, in the presence of at least one co-reactant selected from the glycidyl ether derivatives of biosourced polyols; and
b. of one or more glycidyl ether derivatives of biosourced polyols with at least one cross-linking agent.

2. The biosourced epoxy resin according to claim 1, characterized by a ratio of the number of reactive groups of the cross-linking agent to the total number of epoxy groups present in the epoxidized oil/co-reactant mixture, equal to the ratio of the number of reactive groups of the cross-linking agent to the total number of epoxy groups of the lipid derivative or derivatives if they were used as the sole source of epoxy groups.

3. Biosourced epoxy resins according to claim 1, characterized in that the one or more biosourced epoxidized lipid derivatives are extracted from a natural vegetable oil, in particular vernonia oil, in which they are present in epoxidized form.

4. The biosourced epoxy resin according to claim 1, characterized in that the epoxidized lipid derivative or derivatives are obtained by epoxidation of lipids extracted from natural vegetable oils selected from the group comprising flax oil, hemp oil, sunflower oil, colza oil, soya oil, olive oil, grapeseed oil, tung wood oil, cotton oil, maize oil, hazelnut oil, walnut oil, coconut oil, palm oil, castor oil, cashew nut oil, peanut oil, calabash oil, margosa oil and loofah oil and mixtures thereof or extracts of animal oils.

5. The biosourced epoxy resin according to claim 1, characterized in that the glycidyl ether derivative of polyol used as co-reactant or alone is obtained by epoxidation of glycerol or of a polyglycerol derived from vegetable oils and corresponds to formula (I) 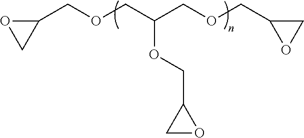
where n is an integer comprised between 1 and 20, in particular the glycidyl ether derivative of glycerol and the glycidyl ether derivative of diglycerol.

6. The biosourced epoxy resin according to claim 1, characterized in that the glycidyl ether derivative of polyol used as co-reactant or alone is obtained by epoxidation of a sugar, and is in particular the glycidyl ether derivative of sorbitol.

7. The biosourced epoxy resin according to claim 1, characterized in that the at least one cross-linking agent is selected from one of:
a. from the group comprising compounds bearing amine functions, said compounds, when bearing primary amine functions, being selected from the group comprising the diamines, the polyamines and mixtures thereof; and
b. from the group of acid anhydrides.

8. The biosourced epoxy resin according to claim 7, characterized in that, when the at least one cross-linking agent is a compound bearing N—H groups, belonging to primary or secondary amine functions, the ratio of the number of N—H groups to the number of epoxy groups is equal to unity.

9. The biosourced epoxy resin according to claim 7, characterized in that, when the at least one cross-linking agent is an acid anhydride, the ratio of the number of acid anhydride groups to the number of epoxy groups is equal to unity.

10. A process for preparing biosourced epoxy resins according to claim 1, comprising: a step of mixing one or more biosourced epoxidized lipid derivatives with at least one cross-linking agent, in the presence of at least one co-reactant selected from the glycidyl ether derivatives of biosourced polyols.

11. The process for preparing biosourced epoxy resins according to claim 1, characterized in that it comprises the following steps:
a. mixing one or more biosourced epoxidized lipid derivatives;
b. adding the co-reactant and then carrying out a mixing operation to obtain a homogeneous epoxy mixture;
c. adding the cross-linking agent to said mixture and then carrying out a further mixing operation;
d. and then leaving the resin to react.

12. A use of biosourced epoxy resins according to claim 1, in composite parts for mechanical construction or for building and in structural parts for construction, transport, aerospace, water sports, sports and leisure.

13. The use of biosourced epoxy resins according to claim 12, characterized in that the applications involve structural parts exposed to fatigue or parts subjected to thermal variations.

14. A use of biosourced epoxy resins according to claim 1 as adhesives, preferably as structural adhesives or as surface coatings.
